(19) United States
(12) Patent Application Publication
(10) Pub. No.: US 2014/0116190 A1
(43) Pub. Date: May 1, 2014

(54) BICYCLE CABLE AND MANUFACTURE THEREOF

(71) Applicant: Shimano Inc., Osaka (JP)

(72) Inventors: Yoko SUGII, Osaka (JP); Naoya KATO, Tokyo (JP); Satoru SASAKI, Aomori (JP); Takashi SAKAMOTO, Aomori (JP); Yoshihisa KOBAYASHI, Tokyo (JP); Yuichi MORISHITA, Tokyo (JP)

(73) Assignee: Shimano Inc., Osaka (JP)

(21) Appl. No.: 13/968,310

(22) Filed: Aug. 15, 2013

(30) Foreign Application Priority Data
Nov. 1, 2012 (JP) 2012-242233

(51) Int. Cl. F16C 1/20

(52) U.S. Cl. CPC F16C 1/20
USPC 74/502.5; 156/176

(57) ABSTRACT

A bicycle cable is configured to be inserted in a hollow member of a bicycle. The bicycle cable basically includes a cable body and a pair of plastic tape pieces. The plastic tape pieces are attached to the cable body such that the cable body is interposed between the plastic tape pieces with a thermal adhesive layer sealing the plastic tape pieces to together with thermal adhesion. The plastic tape pieces form a pair of longitudinal extending fins projecting outwardly on both sides of the cable main body.

### CROSS-REFERENCE TO RELATED APPLICATIONS

This application claims priority under 35 U.S.C. §119 to Japanese Patent Application No. 2012-242233, filed Nov. 1, 2012. The entire disclosure of Japanese Patent Application No. 2012-242233 is hereby incorporated herein by reference.

### BACKGROUND

1. Field of the invention

This invention generally relates to a bicycle cable and the manufacture thereof More specifically, the present invention relates to a bicycle cable that is arranged within a hollow member.

2. Background Information

Typically, especially in the past, mechanical brake operating devices and other handlebar mounted control devices (e.g., shifters) for bicycles are attached to the handlebars and connected to a brake device or a gear changing device via a push-pull control cable to enable operation. In addition, electronic gear shifter systems have become commercially available that control a bicycle's gear-changing operation by a computer. With this kind of system, a gear-change command is transmitted by an electrical signal from the operating devices mounted on the handlebars to a gear changing device at the rear wheel. Often, an electrical cable is used to transmit an electrical current for transmitting the electrical signal to operate the gear changing device. Thus in recent years, a variety of cables are used to transmit electrical current or electric signals in bicycles.

Conventionally, these mechanical and electrical cables have typically been fastened along the outside of a bicycle frame and other hollow members such as the handlebars. However, more recently, cables are sometimes inserted inside of these hollow members to preserve an external appearance of the bicycle and for protection of the cables. For example, Japanese Unexamined Patent Publication No. 2005-53363 discloses cables extending inside of hollow members of a bicycle. However, since the cable is arranged inside of the hollow member without fastening, there can be a problem of unpleasant noise (knocking or the like) arising from the cable contacting an inner surface of the hollow member due to the vibration of the bicycle during riding.

### SUMMARY

Consequently, in view of the state of the known technology, it has been discovered that there is a need for a bicycle cable that does not generate unpleasant noise when installed within a hollow member. The cable disclosed herein was developed to solve this problem of the conventional technology. One object presented in this disclosure is to provide a bicycle cable, which can be disposed within a hollow member of a bicycle, such as the frame and the handlebars or the like, that can suppress the unpleasant noise generated due to the cable contacting the inner surface of the hollow member.

In accordance with a first aspect of the present disclosure, a bicycle cable is configured to be inserted in a hollow member of a bicycle. The bicycle cable basically comprises a cable body and a pair of plastic tape pieces. The plastic tape pieces are attached to the cable body such that the cable body is interposed between the plastic tape pieces with a thermal adhesive layer sealing the plastic tape pieces to together with thermal adhesion. The plastic tape pieces form a pair of longitudinal extending fins projecting outwardly. on both sides of the cable main body.

In accordance with a second aspect of the present invention, the bicycle cable according to the first aspect is configured so that each of the fins has a width that is larger than an outer diameter of the cable body.

In accordance with a third aspect of the present invention, the bicycle cable according to the first or second aspect is configured so that the widths of the fins lie within a range between not less than 1.4 times the outer diameter of the cable body and not greater than 7.0 times the outer diameter of the cable body.

In accordance with a fourth aspect of the present invention, the bicycle cable according to any one of the first to third aspects is configured so that each of the fins has a thickness that is not less than 25 μm.

In accordance with a fifth aspect of the present invention, the bicycle cable according to the any one of the first to fourth aspects is configured so that the hollow member is at least one of a bicycle frame and a bicycle handlebar.

In accordance with a sixth aspect of the present invention, a bicycle cable manufacturing method is carried out for manufacturing a bicycle cable that is to be inserted in a hollow member of a bicycle, the method comprises providing a cable body; placing bicycle cable plastic tape pieces on the cable body such that the cable body is interposed between the plastic tape pieces; and passing the cable body interposed between the plastic tape pieces through heated pressure rollers to integrally heat seal the plastic tape pieces on the cable body such that the plastic tape pieces form a pair of longitudinal extending fins projecting outwardly on both sides of the cable main body.

In accordance with a seventh aspect of the present invention, the bicycle cable manufacturing method according to the sixth aspect is carried out so that each of the plastic tape pieces includes a thermal adhesive layer.

As described herein, a bicycle cable, which is to be disposed within a hollow member of a bicycle, such as the frame and the handlebars or the like, is provided to suppress the unpleasant noise generated from the cable contacting the inner surface of the hollow member. Also, as described herein a bicycle cable can be reliably manufacture that has excellent noise reduction effect.

Also other objects, features, aspects and advantages of the disclosed bicycle cable will become apparent to those skilled in the art from the following detailed description, which, taken in conjunction with the annexed drawings, discloses one embodiment of the bicycle cable.

### BRIEF DESCRIPTION OF THE DRAWINGS

Referring now to the attached drawings which form a part of this original disclosure:

FIG. 1 is a perspective view of a bicycle cable in accordance with one illustrated embodiment;

FIG. 2 is a transverse cross sectional view of the bicycle cable illustrated in FIG. 1;

FIG. 3 is a simplified elevational side view of a bicycle equipped with the bicycle cable in accordance with the illustrated embodiment of FIGS. 1 and 2; and

FIG. 4 is a simplified, schematic diagram illustrating an example of machine for manufacturing the bicycle cable illustrated in FIGS. 1 and 2.

### DETAILED DESCRIPTION OF EMBODIMENTS

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

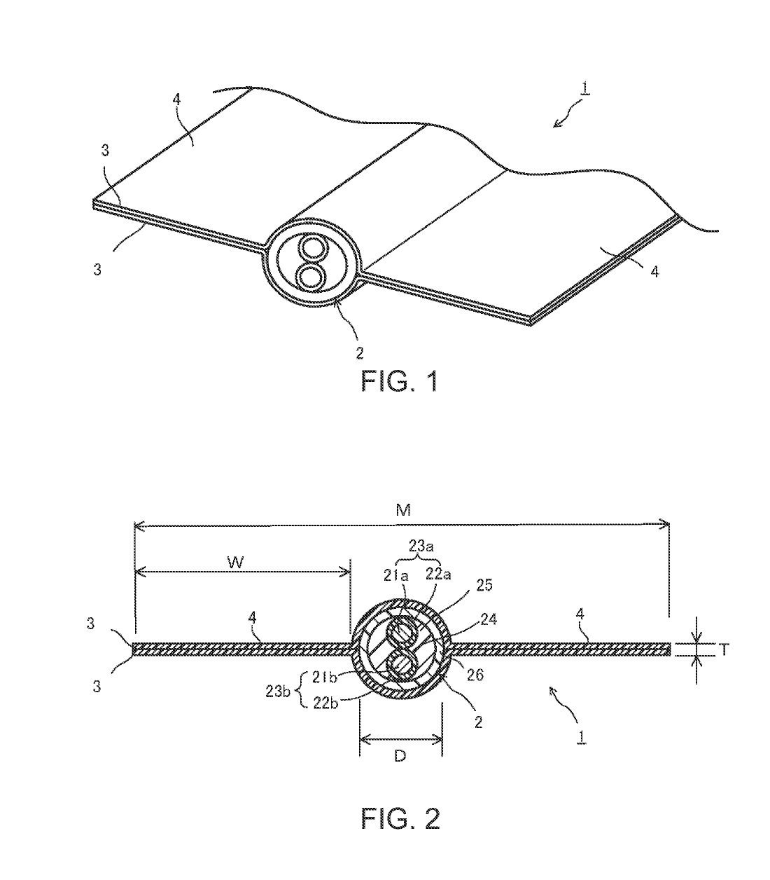

Referring initially to FIGS. 1 and 2, a bicycle cable 1 is illustrated in accordance with a first embodiment. FIG. 1 is a perspective view of the bicycle cable 1, while FIG. 2 is a transverse cross sectional view of the bicycle cable 1. The bicycle cable 1 basically includes a cable body 2 and a pair of plastic tape pieces 3. The plastic tape pieces 3 are disposed such as to interpose the cable body 2. The plastic tape pieces 3 are superposed such that the cable body 2 is positioned at the width direction center thereof and this superposed section is integrally sealed according to thermal adhesion. As a result, the plastic tape pieces 3 form two fins 4 that extend in the length direction on both sides of the cable body.

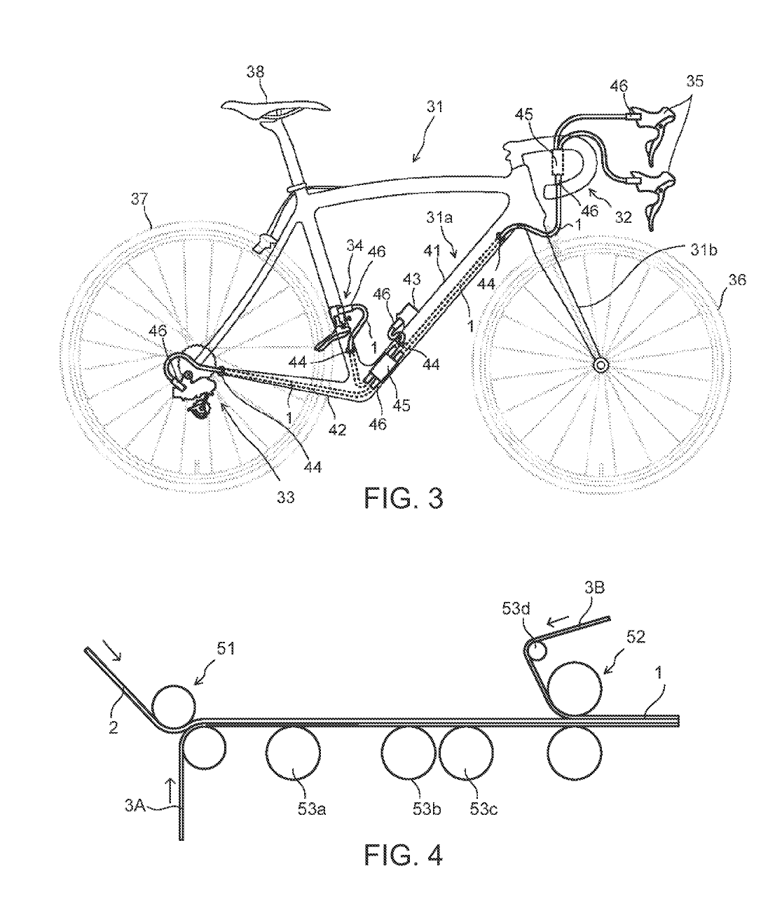

As seen in FIG. 3, a simplified elevational side view of a bicycle is illustrated in which the bicycle cable 1 has been inserted and disposed within the hollow members of the bicycle, such as the frame and the handlebars or the like. The bicycle cable 1 is arranged within the hollow members of the bicycle such that the plastic tape pieces 3 suppress the generation of unpleasant noise when the cable 1 is arranged within one or more of the hollow members of the bicycle.

Each of the fins 4 preferably have a width W such that, when the bicycle cable 1 is inserted within one or more hollow members of the bicycle, the cable body 2 can be supported within the hollow member(s) by the fins 4 without the cable body 2 striking the inner surface of the hollow member(s). Specifically, the cable 1 preferably has a maximum width M that is not less than 0.8 times an inner diameter of the hollow member in which the bicycle cable 1 is arranged. If the maximum width M of the cable is less than 0.8 times the inner diameter of the hollow member, there is a concern that the unpleasant noise generated from the cable striking the inner surface of the hollow members will not be suppressed sufficiently. Here, “the inner diameter of the hollow member” refers to a diameter in a case wherein a cross-sectional shape of the hollow section is circular, a diameter of an inscribed circle thereof in a case wherein the cross-sectional shape of the hollow section is rectangular or polygonal, and a length of a short axis thereof in a case wherein the cross-sectional shape of the hollow section is elliptical. Also, in the case when an inner part of the hollow members is divided into multiple spaces and the cable 1 is inserted within the divided spaces, “the inner diameter of the hollow member” refers to an inner diameter of these divided spaces.

Also, from the standpoint of suppressing the generation of unpleasant noise, the widths W of each of the fins 4 is preferably greater than an outer diameter D of the cable body 2, and more preferably lie in a range between not less than 1.4 times and not greater than 7.0 times the outer diameter D of the cable body 2. Here, “the outer diameter of the cable body” refers to a diameter thereof in a case wherein a cross-sectional shape of the cable body 2 is circular and a maximum width of the fins 4 in a case wherein the cross-sectional shape of the cable body 2 is rectangular.

Furthermore, a thickness T of each of the fins 4 is preferably not less than 25 μm. If the thickness T is less than 25 μm, then it is not possible to sufficiently support the cable body 2 within the hollow member, the cable body 2 strikes the inner surface of the hollow member, and there is a concern regarding unpleasant noise being generated. However, if the thickness T of the fins 4 is too thick, the rigidity of the fins 4 will be made too great, and the workability when inserting the bicycle cable 1 into the inner part of the hollow member degrades. Therefore, the thickness T of each of the fins 4 is preferably not greater than 250 μm. From the standpoint of suppressing the generation of unpleasant noise even more and enhancing the workability for inserting the cable even more, the thickness T of each of the fins 4 is preferably not less than 50 μm and not greater than 150 μm.

In this embodiment, a plastic tape that has a thermal adhesive layer is used as the plastic tape pieces 3 that form the fins 4. Plastic tape with a thermal adhesive layer can be seated according to thermal adhesion without using an adhesive. Therefore, concern regarding having a negative effect, such as a deformation in the external shape of the cable body 2 or the like, during adhesion is minimized. Also, the plastic tape has a moderate rigidity. Therefore, the cable body 2 can be supported within the hollow member without making contact with the inner surface thereof and the generation of unpleasant noise caused by the cable body 2 striking the inner surface of the hollow member can be suppressed. Furthermore, the rigidity is moderate; hence, the work of arranging the cable within the hollow member can be carried out efficiently.

In this embodiment, the cable body 2 is arranged at the width direction center position of the plastic tape pieces 3. Therefore, the fins 4 are formed to have the same width. However, this embodiment is not limited to this configuration, and the cable body 2 can be arranged by being displaced to one side of the width direction center position of the plastic tape pieces 3. In this case, the fins 4 are formed to have varying widths. However, from the stand point of suppressing the unpleasant noise generated by the cable striking the inner surface of the hollow members, the cable body 2 is preferably arranged at width direction centers or approximately at centers of the plastic tape pieces 3 such that the fins 4 have the same width or approximately the same width.

Next, the cable body 2 will be described. The cable body 2 is not limited to that used in this embodiment, but different types of conventionally known bicycle cables can also be used. In the example illustrated in the drawings, the cable body 2 includes a first stranded conductor 21a and a first insulator 22a that form a first insulated core wire 23a of the cable body 2. In illustrated embodiment, for example, the first stranded conductor 21a includes a plurality of annealed copper wires, and the first insulator 22a is colored with a first color such as red. The cable body 2 further includes a second stranded conductor 21b and a second insulator 22b that form a second insulated core wire 23b of the cable body 2. In illustrated embodiment, for example, the second stranded conductor 21b includes a plurality of annealed copper wires, and the second insulator 22b is colored with a first color such as black. The first and second insulated core wires 23a and 23b form a twisted pair core 24. In other words, in the illustrated embodiment, the twisted pair core 24 is made by twisting a pair of insulated core wires (e.g., the first and second insulated core wires 23a and 23b). The cable body 2 further includes a first cover 25 and a second cover 26. The first cover 25 is provided on the twisted pair core 24 so as to define an inside outer sheath made of a polyvinylchloride resin sufficiently. The second cover 26 is provided on the first cover 25 and a second cover 26 so as to define an outside outer sheath made of a polyurethane resin.

The diameter of each of the annealed copper wires, which comprises the stranded conductors 21a and 21b, is preferably in a range of, for example, not less than 0.06 mm and not greater than 0.10 mm. The outer diameter of the stranded conductors 21a and 21b are preferably in a range of for example, not less than 0.4 mm and not greater than 0.6 mm. Plating of tin, silver or the like can be applied to the annealed copper wire. In the example in the drawings, the stranded conductors 21a and 21b are formed of, for example, thirty strands of 0.08-mm diameter annealed copper wires that are right-twisted together with a pitch of up to 10.2 mm such that the outer diameters of the stranded conductors 21a and 21b are about 0.51 mm.

The insulators 22a and 22b covering the stranded conductors 21a and 21b are preferably both made of high-density polyethylene. Also preferably the insulators 22a and 22b have a density of not less than 0.950 g/cm³ and not greater than 0.960 g/cm³ according to the JIS K 7112 standard method of determining density. The high-density polyethylene, which forms the insulator 22a, contains a coloring agent for red coloring, for example. On the other hand, the high-density polyethylene, which forms the other insulator 22b, contains a coloring agent for black coloring, for example. The high-density polyethylene used for each insulator is cross-linked, and has a gel fraction that is normally not less than 30% and not greater than 80%. The gel fraction is measured by the JIS C 3005 standard testing method for determining the degree of crosslinking. Furthermore, in addition to the aforementioned coloring agents, the high-density polyethylene may also contain antioxidants, thermal aging inhibitors, bulking agents, processing aids and other additives.

The thicknesses of the insulators 22a and 22b are, for example, not less than 0.10 mm and not greater than 0.20 mm. In the example in the drawing, the high-density polyethylene insulators 22a and 22b are cross-linked by electron beam irradiation, and are formed to a thickness of, for example, 0.17 mm. The first insulated core wire 23a and the second insulated core wire 23b are formed into the twisted pair core 24 by right-twisting together with a pitch of, for example, 20 mm.

The first covering 25 includes a polyvinylchloride resin containing a coloring agent. Besides the coloring agent, depending on requirements, the polyvinylchloride resin may also contain antioxidants, ultraviolet absorbers, thermal aging inhibitors, bulking agents, processing aids, lubricants and other additives. Suitable products on the market for use as the base resin for the polyvinylchloride resin include, for example, polyvinylchloride with a low-temperature resistance of −35° C. in accordance with the JIS K 6723 standard, a tensile strength of 22.6 MPa in accordance with JIS K 6723, 340% stretch in accordance with the same standard and a 100% modulus of 11.2 1MPa, again in accordance with the same standard.

The thickness of the first covering 25 is, for example, not less than 0.100 mm and not greater than 0.200 mm. In the example in the drawing, the first covering 25 is formed to a thickness of 0.125 mm. Further, the thickness (t) of the first covering 25 is the minimum thickness of the first covering 25 and can be determined by the following formula.

t=[D₁−(d₁+d₂)]/2

In the formula, D1 represents the outer diameter of the first covering 25, and d1 and d2 represent the outer diameters of the first insulated core wire 23a and the second insulated core wire 23b, respectively.

The second covering 26 includes a polyurethane resin containing a coloring agent. Besides the coloring agent, depending on requirements, the polyurethane resin may also contain antioxidants, ultraviolet absorbers, thermal aging inhibitors, bulking agents, processing aids, lubricants and other additives. Suitable products on the market for use as the base resin for the polyurethane resin include, for example, polyurethane resin with a tensile strength of 31 MPa in accordance with JIS K 7311, 440% stretch in accordance with the same standard measurement and a 100% modulus of 4.0 MPa, again in accordance with the same standard.

The thickness of the second covering 26 is, for example, not less than 0.30 mm and not greater than 0.50 mm. In the example in the drawing, the second covering 26 is formed to a thickness of 0.35 mm.

In the bicycle cable it configured in this way, the fins 4 extending in the longitudinal direction are formed on both sides of the cable body 2, and these fins 4 act as a cushioning material (a shock-absorbing material) on the insertion and disposal of this bicycle cable 1 in the hollow members of a bicycle, such as the frame and handlebars, thereby enabling the suppression of unpleasant noise, such as knocking or the like, generated by the conventional cables due to their contact with the inner surface of the hollow members.

FIG. 3 illustrates a bicycle arranged with the bicycle cable 1 in this embodiment. In FIG. 3, this bicycle has a frame 31 includes a frame body 31a and front forks 31b, a pair of handle sections 32 forming a handlebar, a first and second gear changer 33 and 34, a pair of shift operating members 35 to operate the first and second gear changers 33 and 34, a front wheel 36, a rear wheel 37, a saddle 38, and other components.

The frame body 31a of the frame 31 has a V-shaped main frame 41 and a pair of arms 42 extending from the bend section of the main frame 41 to near the first gear changer 33 of the rear wheel 37. The main frame 41 and the arms 42 are formed from a cylindrical tube made of a suitable material, such as aluminum alloy or carbon, and the main frame 41 and the arms 42 are constructed with a connecting hollow section at the bend section of the main frame 41. A battery device 43 is mounted on the main frame 41 for providing electrical power to at least the first and second gear changers 33 and 34.

In the illustrated embodiment, the main frame 41 and the arms 42 are provided with cable insertion holes 44 for the bicycle cables 1 to enter or exit from the interior of the main frame 41 and the arms 42. Here, six of the bicycle cables 1 are used in the bicycle of FIG. 3. Two connecting devices 45 are used to interconnect the bicycle cables 1. Preferably, each end of the bicycle cables 1 has a connector 46 that plugs into one of the connecting devices 45 or one of the bicycle components.

The cable insertion holes 44 are perforations in the main frame 41 and the arms 42 for the bicycle cables 1 to be inserted from the outside and to be drawn to the outside. Each of the bicycle cables 1 is drawn out through one these insertion holes 44 to connect with each device, namely, the first gear changer 33, the second gear changer 34, the operating part 35 and the shift operating members 35. The fins 4 are removed from the section where the bicycle cable 1 is drawn to the outside from the cable insertion holes 44.

A first one of the bicycle cables 1 electrically connects the first gear changer 33 to lower one of the connecting devices 45. A second one of the bicycle cables 1 electrically connects the second gear changer 34 to the lower one of the connecting devices 45. A third one of the bicycle cables 1 electrically connects one of the shift operating members 35 to an upper one of the connecting devices 45. A fourth one of the bicycle cables 1 electrically connects the other of the shift operating members 35 to the upper one of the connecting devices 45. A fifth one of the bicycle cables 1 electrically connects the connecting devices 45 together. A sixth one of the bicycle cables 1 electrically connects the battery device 43 to the lower one of the connecting devices 45.

In a bicycle of this kind, the bicycle cable 1 of this embodiment, namely, a cable formed with a pair of fins that extend in the longitudinal direction on both sides of the cable body, is used as the cable inserted within the main frame 41 and the arms 42; therefore, the fins become a cushioning material that enables the suppression of unpleasant noise generated by the cable making contact with the inner surfaces of the main frame 41 and the arms 42 due to vibration when riding a conventional bicycle. This allows a rider to ride the bicycle without the annoyance of unpleasant noise.

Next, the manufacture of the bicycle cable 1 in this embodiment will be described,

FIG. 4 is a schematic diagram to illustrate an example of a machine used to manufacture the bicycle cable 1 in this embodiment. This manufacturing machine includes a pair of room-temperature pressure rollers 51 disposed to be approximately vertical with parallel rotating axes. This manufacturing machine includes a pair of heated pressure rollers 52 disposed to be approximately vertical with parallel rotating axes. This manufacturing machine further includes a plurality of guide rollers 53a to 53d disposed between the room-temperature pressure rollers 51 and the heated pressure rollers 52.

First, one piece of polyester tape (i.e., a bottom polyester tape 3A) is delivered from a delivery device (not shown in the drawing) to the room-temperature pressure rollers 51. The bottom polyester tape 3A includes a thermal adhesive layer that is arranged along a bottom side of the cable body 2. The bottom polyester tape 3A is then guided by the guide rollers 53a to 53c to the heated pressure rollers 52. Now another piece of polyester tape (i.e., a top polyester tape 3B) is delivered from a delivery device (not shown in the drawing) to the heated pressure rollers 52. Preferably, the top polyester tape 3B includes a thermal adhesive layer that is arranged along a top side of the cable body, and the bottom polyester tape 3A and the top polyester tape 3B are integrally heat sealed. Accordingly, the bicycle cable 1 like that illustrated in FIGS. 1 and 2 is obtained.

If the temperature of the heated pressure rollers 52 is too low or the heating time (the time the bottom polyester tape 3A and the top polyester tape 3B are making contact with the heated pressure rollers 52) is too short, the bonding strength between the bottom polyester tape 3A and the top polyester tape 3B is made insufficient. On the contrary, if the temperature of the heated pressure rollers 52 is too high or the heating time is too long, the surface of the cable body 2 fuses with the bottom polyester tape 3A and the top polyester tape 313. As a result, the bottom polyester tape 3A and the top polyester tape 3B shrink greatly after cooling, and there is a concern over waviness being created in the cable body or the insulated core wire within the cable body protruding. Therefore, suitably adjusting the temperature of the heated pressure rollers 52 and the delivery speed of the cable body 2 is preferred.

The bicycle cable 1 and the manufacture thereof were described above, but the present invention is not limited to these embodiments and can be embodied with components modified at the implementation stage without departing from the scope thereof In addition, various inventions can be formed through multiple suitable combinations of the components disclosed by the embodiments described above.

For example, with the aforementioned embodiment, the cable body 2 is an electrical cable used in an electronic gear changer system. However, the present invention is not limited to this kind of cable. The cable body 2 can also be the kind of push-pull control cable used in mechanical bicycle brake devices and gear changing devices.

Next, the bicycle cable 1 will be described in greater detail with reference to the illustrated embodiments, although the present invention is not limited to these embodiments.

### First Embodiment

A stranded conductor with an outer diameter of 0.50 mm was obtained by right-twisting 30 strands of tin-plated copper wire with a diameter of 0.08 mm and a pitch of approximately 10 mm. Two stranded conductors obtained in this way were prepared, one of which was given an extrusion covering of a high-density polyethylene having a density of 0.951 g/cm³ as measured by JIS K 7112 that was mixed in a red master batch, which was subsequently irradiated by an electron beam, to form a red insulator having a thickness of 0.17 mm and a 40% gel fraction, as the first insulated core wire. The other stranded conductor, after extrusion covering with the same high-density polyethylene mixed in a black master batch, was irradiated by electron beam, forming a black insulator of a thickness of 0.17 mm and a 40% gel fraction, as the second insulated core wire. Further, the mass mixture ratio of the high-density polyethylene and the master batch is 1:30 in each case.

Then, the first insulated core wire and the second insulated core wire were right twisted with a pitch of approximately 20 mm to form a twisted pair core that was fully extrusion covered with polyvinylchloride such that the outer diameter becomes 1.95 mm; then, an extrusion covering of polyurethane was applied to manufacture a 2.65-mm outer diameter cable body for a bicycle.

Next, a bicycle cable, wherein the maximum width M is about 25 mm and a pair of fins are formed on both sides, was manufactured under the following conditions with the manufacturing machine illustrated in FIG. 4 by interposing the cable body for a bicycle described above between two pieces of polyester tape of a width of 50 mm and a thickness of 50 μm that includes a thermal adhesive layer and then passing these pieces of polyester tape through the heated pressure rollers to heat seal them.

Linear speed: 0.8 m/sec

Temperature of the heated rollers: 175° C.

Tensile strength of the polyester tape: 5N

### Second to Fourth Embodiments

Bicycle cables with a pair of fins on both sides can be manufactured in the same manner as in the first embodiment except for using polyester tape with the widths and thicknesses indicated in Table 1.

The bicycle cables obtained in the embodiments described above were observed visually, and the presence of bubbles between the pieces of polyester tape, the presence of fusion between the cable body and the polyester tape, the presence of waviness in the cable body, and the presence of the protrusion of the insulated core wire were evaluated. Also, the obtained bicycle cables were arranged within the frame of a bicycle, and the workability was evaluated. The bicycle was also operated to evaluate the generation of unpleasant noise. The results of these evaluations are shown in Table 1. For comparison with the present invention, the results of the evaluations similarly performed on a cable body for a bicycle (a bicycle cable with a conventional structure) before adhering the polyester tape are also shown in Table 1.

TABLE 1

| | Embodiment | | | | Comparative |
|---|---|---|---|---|---|
| | 1 | 2 | 3 | 4 | Example |
| Outer diameter of the cable body (mm) | 2.65 | 2.65 | 2.65 | 2.65 | 2.65 |
| Width of the plastic tape (mm) | 21.5 | 26.5 | 36.5 | 16.5 | — |
| Thickness of the plastic tape (μm) | 50 | 50 | 50 | 50 | — |
| Width of the fin (mm) | 8.6 | 11.1 | 16.1 | 6.1 | — |
| Thickness of the fin (μm) | 100 | 100 | 100 | 100 | — |
| Characteristics of the cable | | | | | |
| Maximum width M (mm) | 20 | 25 | 35 | 15 | 2.65 |
| Bubbles in the plastic tape | No | No | No | No | — |
| Fusion of the cable body and | No | No | No | No | — |
| plastic tape | | | | | |
| Waviness of the cable core | No | No | No | No | — |
| Protrusion of the insulated core wire | No | No | No | No | — |
| Workability | Favorable | Favorable | Favorable | Favorable | Favorable |
| Generation of unpleasant noise | No | No | No | No | Yes |

As evident in Table 1, the characteristics described above were favorable in the bicycle cables related to the embodiments.

While only selected embodiments have been chosen to illustrate the present invention, it will be apparent to those skilled in the art from this disclosure that various changes and modifications can be made herein without departing from the scope of the invention as defined in the appended claims. Thus, the foregoing descriptions of the embodiments according to the present invention are provided for illustration only, and not for the purpose of limiting the invention as defined by the appended claims and their equivalents.

What is claimed is:

1. A bicycle cable for being inserted in a hollow member of a bicycle, the bicycle cable comprising:
a cable body; and
a pair of plastic tape pieces attached to the cable body such that the cable body is interposed between the plastic tape pieces with a thermal adhesive layer sealing the plastic tape pieces to together with thermal adhesion, the plastic tape pieces forming a pair of longitudinal extending fins projecting outwardly on both sides of the cable main body.

2. The bicycle cable according to claim 1, wherein
each of the fins has a width that is larger than an outer diameter of the cable body.

3. The bicycle cable according to claim 2, wherein
the widths of the fins lie within a range between not less than 1.4 times the outer diameter of the cable body and not greater than 7.0 times the outer diameter of the cable body.

4. The bicycle cable according to claim 3, wherein
each of the fins has a thickness that is not less than 25 μm.

5. The bicycle cable according to claim 2, wherein
each of the fins has a thickness that is not less than 25 μm.

6. The bicycle cable according to claim 1, wherein
each of the fins has a thickness that is not less than 25 μm.

7. The bicycle cable according to claim 1, wherein
the widths of the fins lie within a range between not less than 1.4 times the outer diameter of the cable body and not greater than 7.0 times the outer diameter of the cable body.

8. The bicycle cable according to claim 1, wherein
the hollow member is at least one of a bicycle frame and a bicycle handlebar.

9. The bicycle cable according to claim 8, wherein
each of the fins has a width that is larger than an outer diameter of the cable body.

10. The bicycle cable according to claim 9, wherein
the widths of the fins lie within a range between not less than 1.4 times the outer diameter of the cable body and not greater than 7.0 times the outer diameter of the cable body.

11. The bicycle cable according to claim 10 wherein
each of the fins has a thickness that is not less than 25 μm.

13. The bicycle cable according to claim 9, wherein
each of the fins has a thickness that is not less than 25 μm.

13. The bicycle cable according to claim 8, wherein
each of the fins has a thickness that is not less than 25 μm.

14. A bicycle cable manufacturing method for manufacturing a bicycle cable that is to be inserted in a hollow member of a bicycle, the method comprising:
providing a cable body;
placing bicycle cable plastic tape pieces on the cable body such that the cable body is interposed between the plastic tape pieces; and
passing the cable body interposed between the plastic tape pieces through heated pressure rollers to integrally heat seal the plastic tape pieces on the cable body such that the plastic tape pieces form a pair of longitudinal extending fins projecting outwardly on both sides of the cable main body.

15. The bicycle cable manufacturing method according to claim 14, wherein
each of the plastic tape pieces includes a thermal adhesive layer.
